(19) United States
(12) Patent Application Publication
(10) Pub. No.: US 2018/0089012 A1
(43) Pub. Date: Mar. 29, 2018

(54) INFORMATION PROCESSING APPARATUS FOR ANALYZING HARDWARE FAILURE

(71) Applicant: FUJITSU LIMITED, Kawasaki-shi (JP)

(72) Inventor: Tetsuya Kamino, Kawasaki (JP)

(73) Assignee: FUJITSU LIMITED, Kawasaki-shi (JP)

(21) Appl. No.: 15/687,599

(22) Filed: Aug. 28, 2017

(30) Foreign Application Priority Data
Sep. 28, 2016 (JP) 2016-189565

(51) Int. Cl. G06F 11/07

(52) U.S. Cl. CPC G06F 11/079; G06F 11/0751

(57) ABSTRACT

It is provided an information processing apparatus. The information processing apparatus includes a processor and memory storing an instruction for causing the processor to execute a first process and a second process exclusively in a process of an interrupt to Operating System (OS). The second process uses data related to a result of the first process. The processor further executes storing the data in memory which can be accessed by the OS and the process of the interrupt to the OS, and executing a process for instructing the OS to execute the second process.

### CROSS-REFERENCE TO RELATED APPLICATION

This application is based upon and claims the benefit of priority of the prior Japanese Patent Application No. 2016-189565, filed on Sep. 28, 2016, the entire contents of which are incorporated herein by reference.

### FIELD

The embodiments discussed herein are related to an information processing apparatus for analyzing hardware failure.

### BACKGROUND

When a failure occurs in an information processing apparatus such as a server using a plurality of processors, each processor uses an interrupt such as System Management Interrupt (SMI) to perform hardware failure analyses using firmware such as Basic Input Output System (BIOS). Firmware operates exclusively with OS, therefore, each processor executing processes of the OS suspends the processes of the OS and transits to execute processes of the firmware.

A processor which is referred to as a system management processor such as Baseboard Management Controller (BMC) is notified of the results of the failure analyses using firmware. The speed of the data communication used for the notification from the firmware to the system management processor is slower than the speed of the memory access by the processor in view of the operation frequency of the processor. In addition, after the processor completes the notification of the results of the failure analyses, the processor terminates processes using firmware and returns to processes using the OS. Therefore, the notification of the results of the failure analyses using firmware may cause performance degradation of the process using the OS.

Techniques are proposed for preventing the performance degradation of processes using the OS. For example, a technique for dividing processors in an information processing apparatus into a group of processors which can be recognized by the OS and a group of processors which cannot be recognized by the OS (See patent document 1). When the processors in the group of processors which can be recognized by the OS complete the processes of the failure analyses, the processors in the group of processors which can be recognized by the OS transit to the processes of the OS without waiting for the completion of the processes for notifying the system management processors of the result of the failure analyses. On the other hand, when the processors in the group of processors which cannot be recognized by the OS complete the processes of the failure analyses, the processors in the group of processors which cannot be recognized by the OS transit to the processes for notifying the system management processors of the result of the failure analyses.

In addition, a technique is proposed for accumulating the results of the failure analyses using firmware in a queue used for the notification processes in order to separate the processes of the failure analyses from the processes of the notification to the system management processor (See patent document 2). In this technique, after each processor accumulates the results of the failure analyses, each processor transits to the processes of the OS without executing the processes of the notification. And the data accumulated in the queue is transmitted to the system management processor in a notification process which is an interrupt process periodically occurred by the firmware.

The following patent documents describe conventional techniques related to the techniques described herein.

### Patent Document

[Patent document 1] International Publication Pamphlet No. WO 2012/114463

[Patent document 2] Japanese National Publication of International Patent Application No. 2011-164971

### SUMMARY

According to one embodiment, it is provided an information processing apparatus. The information processing apparatus includes a processor, and memory storing an instruction for causing the processor to execute a first process and a second process exclusively in a process of an interrupt to Operating System (OS). The second process uses data related to a result of the first process. The processor further executes storing the data in memory which can be accessed by the OS and the process of the interrupt to the OS, and executing a process for instructing the OS to execute the second process.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a diagram illustrating an example of a configuration of a server according to an embodiment;

FIG. 2 is a diagram illustrating an example of a flowchart of processes executed in a server according to an embodiment;

FIG. 3 is a diagram illustrating an example of a memory area used for interface (IF) according to an embodiment;

FIG. 4 is a diagram illustrating an example of a flowchart of processes for a system management mode (SMM) executed in a server according to an embodiment;

FIG. 5 is a diagram illustrating an example of a flowchart of processes for an error register executed in a server according to an embodiment;

FIG. 6 is a diagram illustrating an example of a flowchart of processes executed subsequent to the processes in FIG. 5 in a server according to an embodiment;

FIG. 7 is a diagram illustrating an example of a flowchart of processes for an OS notification request executed in a server according to an embodiment;

FIG. 8 is a diagram illustrating an example of a flowchart of processes for a factor executed in a server according to an embodiment; and

FIG. 9 is a diagram illustrating an example of the status of each flag and a process for the status.

### DESCRIPTION OF EMBODIMENTS

Even when the techniques as described above are employed to dividing processors into a group of processors which can be recognized by the OS and a group of processors which cannot be recognized by the OS, the performance of the processes executed by the OS may decrease in proportion to the number of the processors which can be recognized by the OS. In addition, even when the results of failure analyses are accumulated in a queue, the processes for notifying the system management processor of the accumulated data are executed by firmware. Therefore, the processors stop the processes of the OS in order to transit to the processes of the firmware. As a result, the processing time for the failure analyses and the notification by the firmware as a whole may not be different between a case in which the processes of the failure analyses are separated from the processes of the notification to the system management processor and a case in which the processes of the failure analyses and the processes of the notification to the system management processor are not separated. Embodiments are described below with reference to the drawings. Configurations of the following embodiment are exemplifications, and the present apparatus is not limited to the configurations of the embodiment.

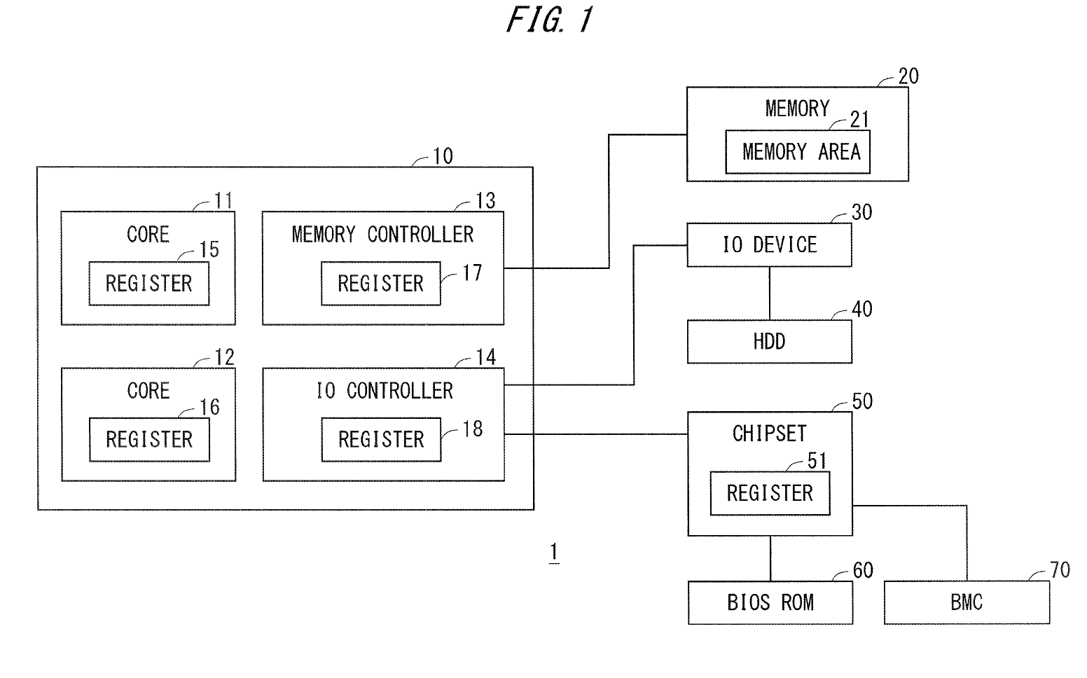

FIG. 1 schematically illustrates a configuration of a server 1 as an example of an information processing apparatus according to an embodiment. For example, the server 1 is an Intel Architecture (IA) server. The server 1 includes a CPU 101, Memory 20, an Input/Output (10) device 30, a Hard Disk Drive (HDD) 40, a chipset 50, BIOS Read Only Memory (ROM) 60 and a BMC 70. The CPU 101 is a so-called multiple-core processor and includes a core 11 and a core 12. It is noted that the number of cores in the CPU is not limited to two. In addition, the CPU 10 includes a memory controller 13 and an IO controller 14. The cores 11, 12, the memory controller 13, the IO controller 14 and the chipset 50 includes a register 15, 16, 17, 18 and 51, respectively.

The BIOS ROM 60 stores BIOS executed in the server 1. In addition, the HDD 40 stores a variety of programs executed in the server 1. For example, when the server 1 starts up, the CPU 10 reads the BIOS from the BIOS ROM 60 to execute initializing processes and the CPU 10 further reads the OS from the HDD 40 to execute the OS.

In the present embodiment, it is assumed that a standard for controlling the status of the power supply and the CPU which is referred to as Advanced Configuration and Power Interface (ACPI) is defined for the OS. The BIOS creates an ACPI table for data communication between the BIOS and the OS on the memory 20. For example, Differentiated System Description Table (DSDT), Secondary System Description Table (SSDT) and Fixed ACPI Description Table (FADT) etc. are defined in the ACPI table. In the DSDT and SSDT, a method for controlling the server 1 is described in an intermediate language such as ACPI Machine Language (AML). The OS interprets the AML to execute processes for accessing to the memory 20 and setting of each register in the server 1.

Hardware information like indicating the validity of the processors is defined in the DSDT and SSDT. In addition, General Purpose Event (GPE) methods such as a \_GPE. TTX method which are executed by the OS when a specific event occurs are also defined in the DSDT and SSDT. An example of the specific event includes a System Control Interrupt (SCI). The CPU 10 can generate an SCI according to the setting of the register 51 in the chipset 50.

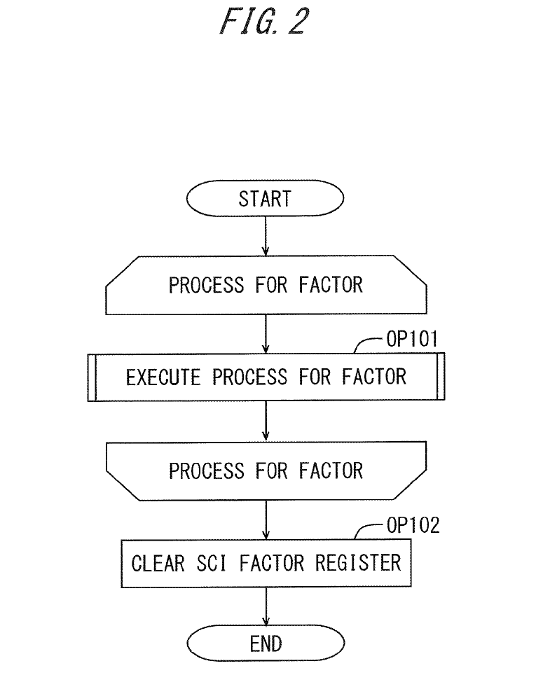

FIG. 2 illustrates a flowchart of processes executed by the cores 11, 12 which is executing the OS when an interrupt such as SCI occurs in the server 1 in the present embodiment. It is assumed here that the OS instructs the core 11 to execute the GPE method. It is noted that the core 11 is an example of an execution unit and a determination unit. When an SCI occurs, the core 11 executes a loop process of a process executed for each factor. In the present embodiment, an example of the process executed for each factor is a process for analyzing the memory area 21 for interface (IF) and notifying the BMC of the result of the analysis as describe later. It is noted that the memory area 21 for IF is an example of a storing unit. When an SCI occurs, one or more factors related to the SCI are stored in the register which is hereinafter referred to as a SCI factor register 51 in the chipset 50. The core 11 calls the GPE method to check the SCI factor register 51 and execute processes for each factor (OP101). When the core 11 completes the processes for each factor, the core 11 clears the SCI factor register 51 (OP102) and terminates the processes of the flowchart.

In addition, the operation modes of the CPU based on the IA include an operation mode referred to as System Management Mode (SMM). Since SMM is a mode intended to be used only for the process of the firmware called a SMM handler, firmware can execute many tasks like analyzing failures without the influence of the OS and applications. Further, each processor in the server 1 transits to the SMM due to SMI, the priority of which is higher than the priorities of the other interrupts such as SCI. And then, one core in the CPU 10 becomes a monarch processor which administrates the other cores in the CPU 10 and allocates processes to the other cores. In SMM, interrupts such as SCI other than SMI are suspended and the suspended interrupts are activated when the processes for SMM are completed. In SMM, the processes of the OS and the applications are suspended and the SMM handler of the BIOS is executed. And the processes of the OS and the applications are resumed after the return from the interrupt of SMM. Therefore, the processing time in SMM may affect the performance of the processes of the OS and the applications.

In the present embodiment, a process for analyzing an error of the hardware in the server 1 is an example of the first process and a process for transmitting data obtained in the process for analyzing the error of the hardware in the server 1 to the BMC 70 is an example of the second process. A process for executing the first process and the second process using the SMM handler is described below as an example of a process for exclusively executing the first process and the second process using an interrupt to the OS.

When a correctable error (CE) occurs in the server 1, the hardware in the server 1 notifies each processor of an SMI via broadcast communication. The SMI handler selects a processor (core) referred to as a monarch processor in order to process the event which is notified by the SMI. The monarch processor waits for the other processors in the server 1 to rendezvous in the SMM before monarch processor initiates processes for the event. The processors which are not the monarch processor stays in the SMM until the monarch processor completes the processes for the event. And when the processes in the SMM are completed, the monarch processor instructs the other processors to exit the SMM.

For example, when a CE of the CPU 11 and the memory 20 etc. occurs in the server 1, information related to the CE is stored in the register of each core of the CPU 10 and the register of the memory controller. The CPU 10 can raise interrupts including a Corrected Machine Check Interrupt (CMCI) and an SMI when a CE occurs. When a CMCI is raised, the CMCI handler of the OS is activated to execute processes including logging of the CE. However, applications for notifying the BMC of the error are used for each OS in this case.

In the present embodiment, while processes such as logging of the CE are executed in the SMM, processes for transmitting notification data including the result of the analysis of the CE to the BMC 70 are executed in the GPE method of ACPI by the OS. It is noted that the process for transmitting the notification data of the result of the analysis of the CE to the BMC 70 is an example of a process which is executed in the SMM and can be executed by the OS.

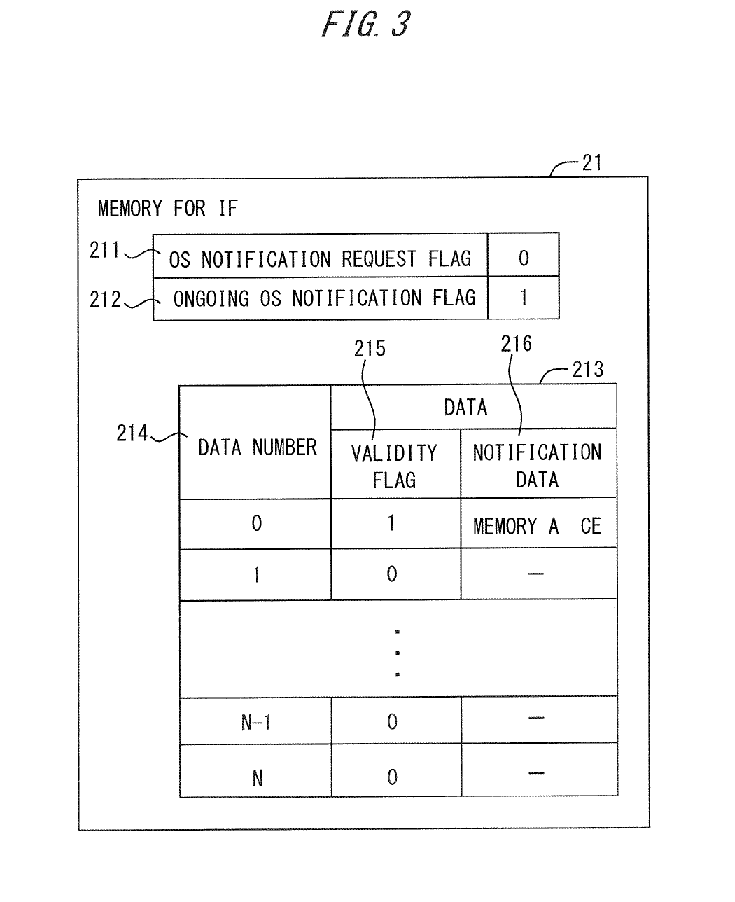

In the present embodiment, the BIOS is executed at the startup of the server 1 and the BIOS allocates a memory area 21 for the interface (IF) which can be accessed by the BIOS and the OS in the memory 20. FIG. 3 illustrates an example of the memory area 21 for IF allocated by the BIOS. As illustrated in FIG. 3, the memory area 21 for IF includes an area for storing a value for an OS notification request flag 211 and a value for an ongoing OS notification flag 212. It is noted that the value for the OS notification request flag 211 is an example of the second indicator and that the value for the ongoing OS notification flag 212 is an example of the first indicator. It is assumed as an example that the OS notification request flag 211, the ongoing OS notification flag 212 and the validity flag 215 are one-bit flags. The state in which the value for the flag is “0” indicates “OFF” and the states in which the value for the flag is “1” indicates “ON”.

The OS notification request flag 211 is a flag used for instructing the OS to process the notification data of the result of the analysis of the CE which is executed in the SMM when the CE occurs in the server 1. The OS refers to the OS notification request flag and executes processes for notifying the BMC 70 of the notification data when the OS notification request flag 211 is ON.

In addition, the ongoing OS notification flag 212 indicates whether the OS is executing the processes for notifying the notification data to the BMC 70. For example, there might be a case in which when the OS is executing the processes for notifying the notification data to the BMC 70 regarding a CE, an additional CE occurs and a process for analyzing the CE in the SMM is executed. In this case, the BIOS checks that the ongoing OS notification flag 212 is ON or OFF to determine whether the notification data of the result of the analysis of the additional CE is processed in the SMM or in the OS.

Further, the memory area 21 for IF includes a data area 213 for storing notification data of results of analyses of CEs. Pairs of values for data number 214, values for validity flag 215 and data for notification data 216 are stored in the data area 213. The BIOS stores notification data indicating the results of the analyses of the CEs in the column of the notification data 216 in the data area 213 and sets the value for the validity flag 215 for the stored notification data to “ON”. In addition, the OS refers to the data area 213 to check the values for the validity flag 215 corresponding to the data for the notification data 214 in ascending order of the numbers stored in the column for the notification data 214. And the OS acquires data for the notification data 216 for which the validity flag 215 is ON and transmits the acquired data to the BMC 70.

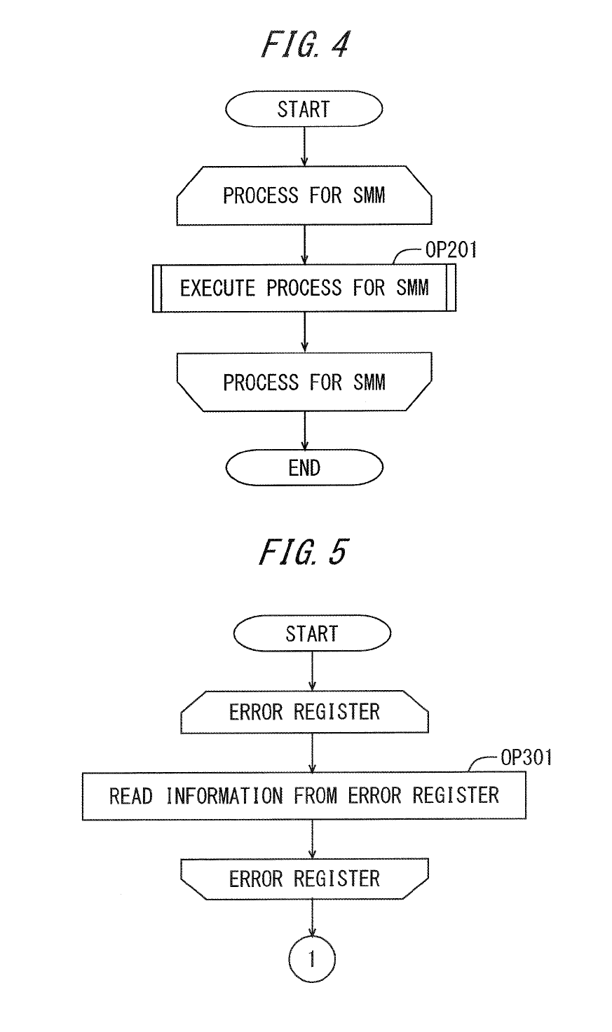

FIG. 4 illustrates an example of a process executed by the cores 11, 12 of the CPU 10 when a CE occurs in the hardware of the server 1. When a CE occurs in the hardware of the server 1, a message of an SMI is transmitted to the cores 11, 12 of the CPU 10 according to the settings of the hardware.

When the cores 11, 12 receives the message of the SMI, the cores 11, 12 transit to SMM. The cores 11, 12 initiate the execution of the SMM handler by the BIOS in the SMM. In the SMM, one of the cores 11, 12 becomes a monarch processor. It is assumed here that the core 11 becomes the monarch processor. It is noted that the processing logic of the BIOS determines whether the core 11 or the core 12 becomes the monarch processor. For example, when a processor for which the Advanced Programmable Interrupt Controller ID (APIC ID) is “n” becomes the monarch processor, each processor in the server 1 can refer to APIC IDs in its own register to determine whether its own processor becomes the monarch processor. In addition, when the cores 11, 12 transit to the SMM, the cores 11, 12 configure the settings for indicating that the cores 11, 12 have transited to the SMM.

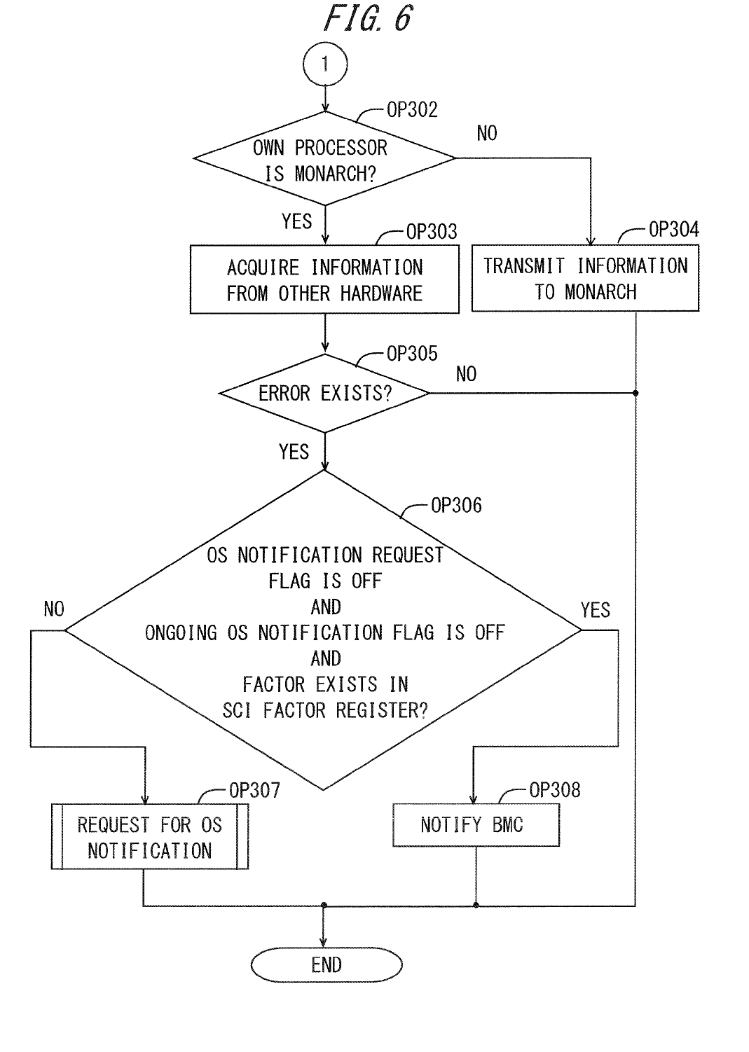

After the core 11 checks that the core 12 transits to the SMM, the core 11 instructs the core 12 to initiate the process illustrated in FIG. 4. In addition, the core 11 also initiates the process illustrated in FIG. 4. The cores 11, 12 execute the loop process for each SMM (OP201). In the present embodiment, the cores 11, 12 execute the process for analyzing the CE as a process for SMM. FIGS. 5 and 6 illustrate a subroutine for analyzing the CE executed in OP201. It is noted that “1” in FIG. 5 connects with “1” in FIG. 6. In the present embodiment, when an error occurs in the hardware of the server 1, the hardware stores information of the error in an error register of its own hardware. The cores 11, 12 in the server 1 read information from the error registers in the registers 15, 16 (the loop process in OP301), respectively. It is noted that the process in OP301 is an example of the first process. When the cores 11, 12 completes the loop process in OP301, the process proceeds to OP302.

In OP302, the cores 11, 12 refers to the respective registers to determine whether the cores 11, 12 become the monarch processor. It is noted in the present embodiment that the core 11 becomes the monarch processor and the core 12 is non-monarch. Therefore, while the core 11 executes the process in OP303 after the core 11 executes the process in OP302, the core 12 executes the process in OP304 after the core 12 executes the process in OP302. The core 11 requests the hardware in the server 1, that is the core 12, the memory controller 13 and the IO controller 14 to transmit information in their own registers to the core 11 (OP303). The core 12, the memory controller 13 and the IO controller 14 transmits the information their own registers to the core 11 in response to the requests from the core 11 (OP304). It is noted that when the hardware elements other than the core 11 which is monarch execute the loop process in OP301 and cannot find information to be transmitted to the core 11 since an error does not occur in its own hardware element, the hardware elements transmit information indicating that an error does not occur in its own hardware element to the core 11.

Next, the core 11 executes the process in OP305. It is noted that the core 11 can determine that an error does not occur in a hardware element by receiving information indicating that an error does not occur from the hardware element.

In OP305, the core 11 determines the hardware element in which an error occurs based on the information of the error register received in OP303. When the core 11 determines that an error occurs in any one of the hardware elements (OP305: YES), the process proceeds to OP306. On the other hand, an error does not occur in any of the hardware elements (OP305: NO), the core 11 terminates the processes in the flowchart.

In OP306, the core 11 refers to the memory area 21 for IF to determine whether both of the OS notification request flag 211 and the ongoing OS notification flag 212 are OFF. In addition, the core 11 checks whether information related to a factor of the error is stored in the SCI factor register in the register 51 of the chipset 50. When both of the OS notification request flag 211 and the ongoing OS notification flag 212 are OFF and the information related to the factor of the error is stored in the SCI factor register in the register 51 (OP306: YES), the process proceeds to OP308. On the other hand, when at least of one of the OS notification request flag 211 and the ongoing OS notification flag 212 is ON or the information related to the factor of the error is not stored in the SCI factor register in the register 51 (OP306: NO), the process proceeds to OP307. In OP308, the core 11 transmits the information of the error acquired in OP303 to the BMC 70.

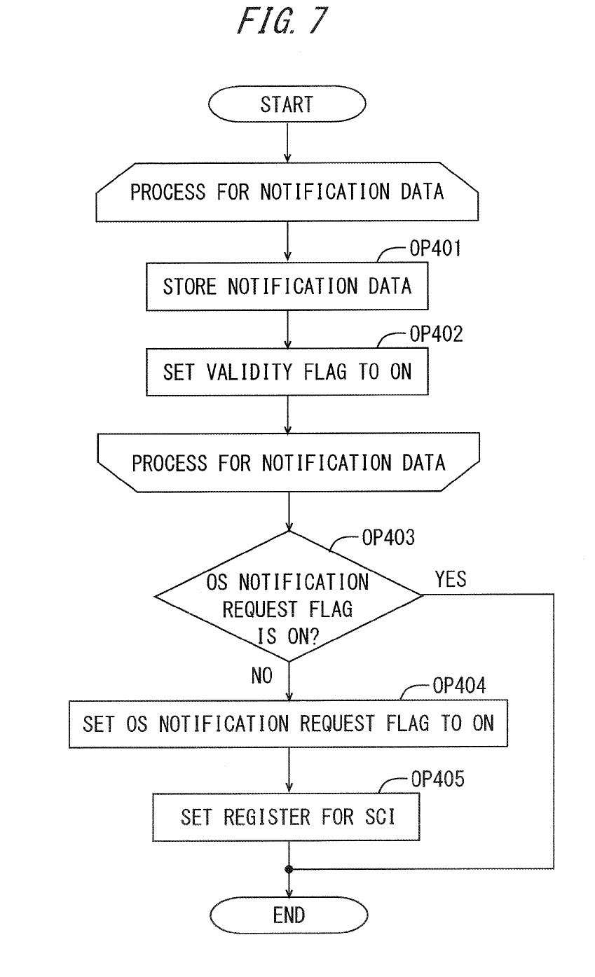

FIG. 7 illustrates a subroutine for OS notification request executed in OP307. First, the core 11 executes the processes in OP401 and OP402 as described below to store notification data which is transmitted to the BMC by the OS in the data area 213 of the memory area 21 for IF in the memory 20. In this case, the core 11 stores the notification data in an area in the column of the notification data 216 in the data area 213 for which the value of the validity flag 215 is not ON. Next, the process proceeds to OP402. In OP402, the core 11 sets the value for the validity flag 215 which is paired with the data stored in the area in the column of the notification data 216 to ON. When the core 11 completes the processes in OP401 and OP402, the core 11 terminates the loop processes and returns to OP403.

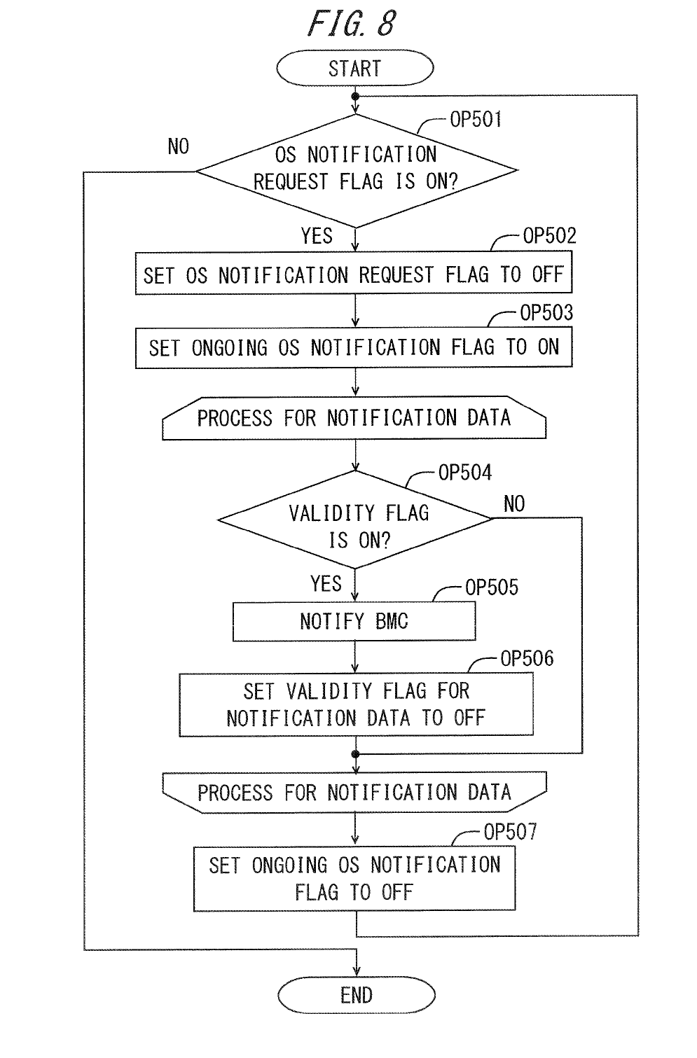

In OP403, the core 11 determines whether the value for the OS notification request flag 211 in the memory area 21 is ON. When the value for the OS notification request flag 211 is ON (OP403: YES), the core 11 terminates the processes in the present subroutine. And the core 11 returns to the subroutine in FIG. 6 and terminates the processes in the subroutine, that is the processes in OP201. On the other hand, when the OS notification request flag 211 is OFF (OP403: NO), the process proceeds to OP404. In OP404, the core 11 sets the OS notification request flag 211 to ON. Next, in OP405, the core 11 sets the register 51 in the chipset to trigger the occurrence of an SCI. With this setting, an SCI occurs to activate an SCI handler of the OS when the processes for SMM are completed. And the core 11 can execute the processes in the subroutine as illustrated in FIG. 8. When the core 11 completes the process in OP405, the core 11 terminates the processes in the subroutine. In addition, the core 11 returns to the processes in the subroutine in FIG. 6 and terminates the processes in the subroutine in FIGS. 5 and 6 (OP201).

In the present embodiment, the cores 11, 12 restart the processes of the OS when the processes in the subroutine in FIGS. 5 and 6 and the processes for SMM in FIG. 4 are terminated. Next, the processes executed by the cores 11, 12 are described below with reference to FIG. 8. When the cores 11, 12 restart the processes of the OS, the OS instructs the core 11 or the core 12 to execute the SCI handler and execute the processes in the flowchart in FIG. 2 when SCI occurs according to the settings in the register 51 set in OP405. It is assumed below that the OS instructs the core 11 to execute the SCI handler. Therefore, the core 11 executes the processes in FIG. 8 as an example of a process in the subroutine executed in OP101.

In OP501, the core 11 determines whether the value for the OS notification request flag 211 in the memory area 21 for IF in the memory 20 is ON. When the value for the OS notification request flag 211 is ON (OP501: YES), the process proceeds to OP502. On the other hand, when the value for the OS notification request flag 211 is OFF (OP501: NO), the core 11 terminates the processes in the present subroutine.

In OP502, the core 11 sets the value for the OS notification request flag 211 to OFF. Next, the process proceeds to OP503. In OP503, the core 11 sets the value for the ongoing OS notification flag 212 to ON. Next, the core 11 executes the loop processes including the processes in OP504, OP505 and OP506 to notify the BMC of the notification data stored in the data area 213. It is noted that the core 11 executes the processes in OP504, OP505 and OP506 in the ascending order of the data number 214, namely starting from the data for which the value in the column for the data number 214 is “0” in the example in FIG. 3.

In OP504, the core 11 determines whether the value for the validity flag 215 which is paired with the data for which the value for the data number 214 is “0” is ON. When the value for the validity flag 215 is ON (OP504: YES), the process proceeds to OP505. On the other hand, when the value for the validity flag 215 is OFF (OP504: NO), the process proceeds to OP506.

In OP505, the core 11 transmits the notification data stored in the area for the notification data 216 which is paired with the data for which the value for the data number 214 is “0” to the BMC 70. It is noted that the process in OP505 is an example of the second process. Next, the process proceeds to OP506. In OP506, the core 11 sets the value for the validity flag 215 which is paired with the data for which the value for the data number 214 is “0” and is determined to be ON in OP504 to OFF. As a result, new notification data can be stored in the area for the notification data 216 which is paired with the data for which the value for the data number 214 is “0”. When the core 11 terminates the process in OP506, the core 11 repeats the processes in OP504, OP505 and OP506 for the data for which the value for the data number 214 is “1”.

Therefore, the core 11 transmits the notification data stored in the area for the notification data 216 to the BMC 70 in the ascending order of the data number 214 when the value for the validity flag 215 is ON. AS a result, the notification data gathered in the error analysis processes in OP201 is transmitted to the BMC 70. After the core 11 executes the processes in OP504, OP505 and OP506 for the data for which the value for the data number 214 is “N” (N is natural number), the core 11 terminates the loop processes and the process proceeds to OP507. In OP507, the core 11 sets the value for the ongoing OS notification flag 212 to OFF. And the process returns to OP501.

As described above, the notification data gathered by the SMM handler is not processed as a process for SMM but is processed as a process of the OS. In conventional techniques, the notification data is transmitted to the BMC 70 as described in OP308 when the core 11, for example, determines in OP305 that an error occurs. In the present embodiment on the other hand, the processes in OP306 and OP307 are executed after the process for checking an error is executed in OP305. It is noted that the processes executed by the core 11 in OP306 and OP307 mainly include a process for accessing the register of each hardware element, a read/write process for the memory 20 and various arithmetic processes. The processes executed in the order of the operation frequency of the cores 11, 12 and the memory 20, namely in the order of nanosecond. On the other hand, the processes for notifying the BMC 70 of the notification data are executed in the order of several tens of milliseconds and take longer than the processes in OP306 and OP307. Thus, the processing time for SMM can be reduced by executing the time-consuming processes for notifying the BMC 70 of the notification data by the OS. The reduction of the processing time has an influence on the time for each core 11, 12 of the CPU 10 to return to the processes of the OS. That is, the larger the number of cores of the CPU implemented in the server is, the greater the effect of preventing the decrease in performance related to the processes for SMM is.

Next, it can be assumed that a new SMI occurs while the processes in FIG. 8 are being executed after the processes in FIGS. 4 to 7 are executed and therefore the core 11 suspends the processes in FIG. 8 to execute the processes in FIGS. 4 to 7 for the new SMI. The processes executed when an SMI occurs during the processes in FIG. 8 are described below.

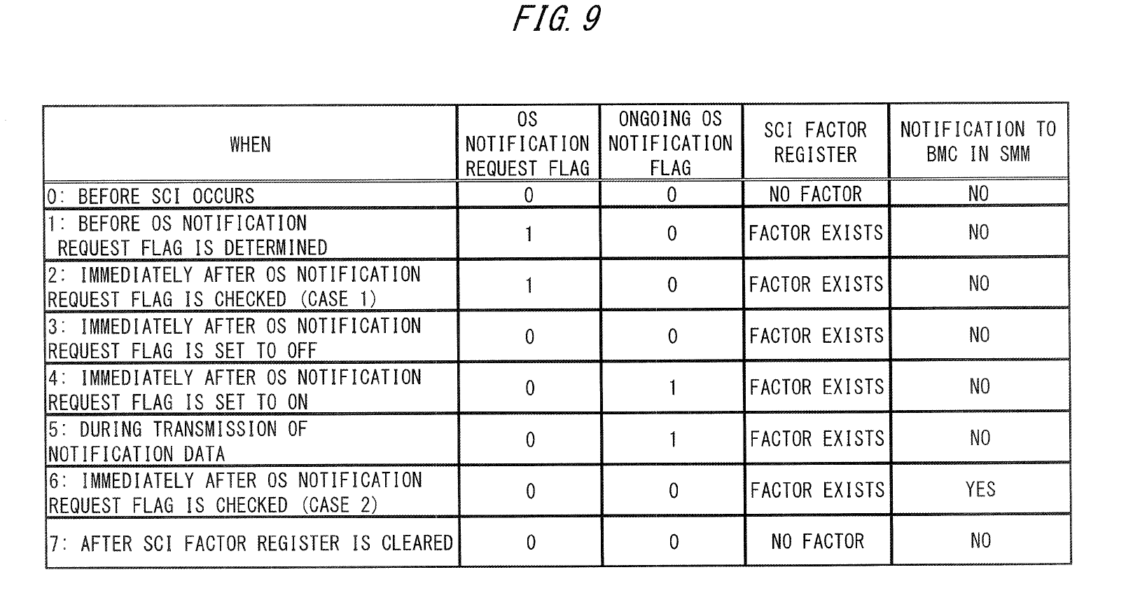

FIG. 9 illustrates as examples the values for the OS notification request flag 211, the values for the ongoing OS notification flag 212, the states of the SCI factor register 51 and the information indicating whether the processes for notifying the BMC 70 of notification data in the processes for SMM are executed in different cases in which SMI occur on different conditions as illustrated in the “When” column in FIG. 9.

A case in FIG. 9 before an SCI occurs, that is before the core 11, 12 start to execute the processes in FIG. 8 is described below. This case corresponds to the case “0: before SCI occur” in FIG. 9. In this case, the values for the OS notification request flag 211 and the ongoing OS notification flag 212 are OFF and information of a factor is not stored in the SCI factor register 51. When a new SMI occurs in this case, the cores 11, 12 execute the processes for SMM as described above. In addition, the core 11 determines NO in OP306 and executes the processes for OS notification request in OP307. Since an SCI occurs when the processes for SMM are completed, the notification data acquired in the error analysis in the processes for SMM is transmitted to the BMC in the processes of the OS as illustrated in FIGS. 2 and 8.

Next, a case in FIG. 9 after an SCI occurs and before the core 11 executes the processes in FIG. 8 to determine the OF notification request flag in OP501 is described below. This case corresponds to the case “1: before OS notification request flag is determined” in FIG. 9. In this case, the OS notification flag 211 is ON, the ongoing OS notification flag 212 is OFF and information of a factor is stored in the SCI factor register 51. When a new SMI occurs in this case, the cores 11, 12 execute the processes for SMM as described above. In addition, the core 11 determines NO in OP306 and executes the processes for OS notification request in OP307.

Next, a case in FIG. 9 after the core 11 determines in OP501 that the OS notification request flag is ON (OP501: YES) and before the core 11 executes the processes in OP502 is described below. This case corresponds to the case “2: immediately after OS notification request flag is checked (case 1)” in FIG. 9. In this case, the OS notification flag 211 is ON, the ongoing OS notification flag 212 is OFF and information of a factor is stored in the SCI factor register 51. When a new SMI occurs in this case, the cores 11, 12 execute the processes for SMM as described above. In addition, the core 11 determines NO in OP306 and executes the processes for OS notification request in OP307.

Next, a case in FIG. 9 after the core 11 sets the OS notification request flag to OFF and before the core 11 executes the processes in OP503 is described below. This case corresponds to the case “3: immediately after OS notification request flag is set to OFF” in FIG. 9. In this case, the OS notification flag 211 and the ongoing OS notification flag 212 are OFF and information of a factor is stored in the SCI factor register 51. When a new SMI occurs in this case, the cores 11, 12 execute the processes for SMM as described above. In addition, the core 11 determines NO in OP306 and executes the processes for OS notification request in OP307.

Next, a case in FIG. 9 after the core 11 sets the OS notification request flag to ON and before the core 11 executes the processes in OP504 is described below. This case corresponds to the case “4: immediately after OS notification request flag is set to ON” in FIG. 9. In this case, the OS notification flag 211 is OFF, the ongoing OS notification flag 212 is ON and information of a factor is stored in the SCI factor register 51. When a new SMI occurs in this case, the cores 11, 12 execute the processes for SMM as described above. In addition, the core 11 determines NO in OP306 and executes the processes for OS notification request in OP307.

In addition, the cases corresponding to “1: before OS notification request flag is determined”, “2: immediately after OS notification request flag is determined (case 1)”, “3: immediately after OS notification request flag is set to OFF” and “4: immediately after OS notification request flag is set to ON” are described in more detail. These cases are cases before the core 11 transmits the notification data to the BMC 70 in OP504, OP505 and OP506. In addition, the notification data gathered for the new SMI is stored in the data area 213 in the memory area 21 for IF. And the execution of the processes in FIG. 8 which is suspended due to the occurrence of the new SMI is restarted after the processes for SMM are completed. As a result, the core 11 executes the processes in OP504, OP505 and OP506 and transmits the notification data which has been stored in the data area 213 before the occurrence of the new SMI and the notification data gathered for the new SMI to the BMC 70.

Next, a case in FIG. 9 when the core 11 is executing the loop processes in OP504, OP505 and OP506 is described below. This case corresponds to the case “5: during transmission of notification data” in FIG. 9. In this case, the OS notification flag 211 is OFF, the ongoing OS notification flag 212 is ON and information of a factor is stored in the SCI factor register 51. When a new SMI occurs in this case, the cores 11, 12 execute the processes for SMM as described above. In addition, the core 11 determines NO in OP306 and executes the processes for OS notification request in OP307.

In addition, the case corresponding to “5: during transmission of notification data” is described in more detail. This case is a case when the core 11 is executing the processes for transmitting the notification data acquired in OP504, OP505 and OP506 in FIG. 8 to the BMC 70. In addition, the notification data gathered for the new SMI is stored in the data area 213 in the memory area 21 for IF. Further, the processes in OP403 and OP404 are executed and the OS notification request flag is set to ON. And the execution of the processes in FIG. 8 which is suspended due to the occurrence of the new SMI is restarted after the processes for SMM are completed.

For example, it is assumed here that a new SMI occurs when the core 11 is executing the processes in OP504, OP505 and OP506 for the pair for which the data number 214 is “k” (k is natural number; k=1 to N). In addition, it is assumed here that the notification data gathered for the new SMI is stored in the data area 213 in the pair for which the data number 214 is “m” (k>m≧0). In this case, even when the execution of the suspended processes in FIG. 8 is restarted, the core 11 executes the processes in OP504, OP505 and OP506 for the data in the pair for which the data number 214 is equal to or more than “k”. Therefore, the core 11 terminates the loop processes in OP504, OP505 and OP506 without transmitting the notification data stored in the data area 213 for the pair for which the data number 214 is “m” to the BMC 70. However, since the OS notification request flag is set to ON as described above, the core 11 determines YES in OP501 when the process proceeds from OP507 to OP501. And the process proceeds to OP502. As a result, the core 11 executes the processes in OP504, OP505 and OP506 again and the notification data stored in the data area 213 for the pair for which the data number 214 is “m” is transmitted to the BMC 70. Thus, the notification data gathered for the new SMI can also be transmitted to the BMC 70.

Next, a case in FIG. 9 when the process proceeds from OP507 to OP501 and the core 11 executes the determination process in OP501 (OP501: NO) and before the core 11 terminates the processes in FIG. 8 is described below. This case corresponds to the case “6: immediately after OS notification request flag is checked (case 2)” in FIG. 9. In contrast to the “case 1” as described above, the OS notification flag 211 and the ongoing OS notification flag 212 are OFF and information of a factor is stored in the SCI factor register 51 in the case 2. When a new SMI occurs in this case, the cores 11, 12 execute the processes for SMM as described above.

In this case, even when the notification data gathered for the new SMI is stored in the data area 213, the core 11 terminates the processes for SMM and restarts the execution of the suspended processes in FIG. 8. However, the core 11 clears the SCI factor register 51 in OP102 when the core 11 terminates the processes in FIG. 8. That is, the notification data gathered for the new SMI is not transmitted to the BMC 70. Therefore, the core 11 determines YES in OP306 and executes the process for BMC notification in OP308 in the present embodiment. As a result, the notification data gathered for the new SMI can be transmitted to the BMC 70.

Next, a case in FIG. 9 when the process terminates the processes in FIG. 8 and executes the process in OP102 is described below. This case corresponds to the case “7: after SCI factor register is cleared” in FIG. 9. In this case, the OS notification flag 211 and the ongoing OS notification flag 212 are OFF and information of a factor is not stored in the SCI factor register 51. When a new SMI occurs in this case, the cores 11, 12 execute the processes for SMM as described above. In addition, the core 11 determines NO in OP306 and executes the process for OS notification in OP307. As a result, the notification data gathered in the error analysis in the process for SMM is transmitted to the BMC not in the process for SMM but in the process of the OS.

Thus, even when a new SMI occurs during the execution of the processes in FIG. 8, the notification data gathered for the new SMI can also be transmitted to the BMC 70.

Although specific embodiments are described above, the configurations of the server etc. described and illustrated in each example can be arbitrarily modified and/or combined. For example, the core 11 executes the processes in FIGS. 2 and 8 in the embodiments as described above. However, the OS notification request flag 211 and the ongoing OS notification flag 212 can be controlled exclusively. In this case, the data processed in FIGS. 2 and 8 can be divided according to the cores in the server 1.

Moreover, the CPU as described above is not limited to a single processor but can be configured as multiple processors. In addition, the CPU can be configured as a multi-core processor and each CPU is connected via a single socket with each other. A part or the whole of the processes can be executed by a Digital Signal Processor (DSP), a Graphics Processing Unit (GPU), a numerical processor, a vector processor, a dedicated processor such as an image processing processor. Furthermore, at least a part of the elements in the above embodiment can be an Integrated Circuit (IC) or a digital circuit. Moreover, an analog circuit can be also used in at least a part of the elements in the above embodiment. The IC includes a Large Scale Integration (LSI), an Application Specific Integrated Circuit (ASIC), and a Programmable Logic Device (PLD). The PLD includes a Field-Programmable Gate Array (FPGA). The above parts can be a combination of a processor and an IC. The combination is referred to as Micro-Controller Unit (MCU), System-on-a-Chip (SoC), system LSI and chipset etc.

<<Computer Readable Recording Medium>>

It is possible to record a program which causes a computer to implement any of the functions described above on a computer readable recording medium. In addition, by causing the computer to read in the program from the recording medium and execute it, the function thereof can be provided.

The computer readable recording medium mentioned herein indicates a recording medium which stores information such as data and a program by an electric, magnetic, optical, mechanical, or chemical operation and allows the stored information to be read from the computer. Of such recording media, those detachable from the computer include, e.g., a flexible disk, a magneto-optical disk, a CD-ROM, a CD-R/W, a DVD, a DAT, an 8-mm tape, and a memory card. Of such recording media, those fixed to the computer include a hard disk and a ROM. Further, a Solid State Drive (SSD) can be used as a recoding medium which is detachable from the computer or which is fixed to the computer.

According to one aspect, it is provided an information processing apparatus which reduces the suspend time of the processes of the OS when a process of an exclusive interrupt to the OS is executed.

All example and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. An information processing apparatus, comprising:
a processor; and
memory storing an instruction for causing the processor to execute:
executing a first process and a second process exclusively in a process of an interrupt to Operating System (OS), the second process using data related to a result of the first process;
storing the data in memory which can be accessed by the OS and the process of the interrupt to the OS; and
executing a process for instructing the OS to execute the second process.

2. The information processing apparatus according to claim 1, wherein the processor further executes:
first determining whether the second process can be executed by the OS; and
executing, when the first determining determines that the second process can be executed by the OS, the storing and the process for instructing the OS to execute the second process.

3. The information processing apparatus according to claim 2, wherein the processor further executes:
storing a first indicator indicating whether the second process is being executed by the OS in the memory; and
second determining, when the first indicator indicates that the second process is being executed by the OS, that the second process can be executed by the OS.

4. The information processing apparatus according to claim 2, wherein the processor further executes:
storing a second indicator indicating whether the OS is instructed to execute the second process or the OS is instructed not to execute the second process in the memory; and
setting, when the second determining determines that the second process can be executed by the OS, the second indicator to indicate that the OS is instructed to execute the second process,
when the second indicator indicates that the OS is instructed to execute the second process, the OS executes the second process after the OS sets the second indicator to indicate that the OS is instructed not to execute the second process, and
the second determining determines, when the second indicator indicates that the OS is instructed to execute the second process, that the second process can be executed by the OS.

5. A non-transitory computer-readable recording medium storing a program that causes an information processing apparatus to execute:
executing a first process and a second process exclusively in a process of an interrupt to Operating System (OS), the second process using data related to a result of the first process;
storing the data in memory which can be accessed by the OS and the process of the interrupt to the OS; and
executing a process for instructing the OS to execute the second process.

6. The non-transitory computer-readable recording medium according to claim 5, wherein the information processing apparatus further executes:
first determining whether the second process can be executed by the OS; and
executing, when the first determining determines that the second process can be executed by the OS, the storing and the process for instructing the OS to execute the second process.

7. The non-transitory computer-readable recording medium according to claim 6, wherein the information processing apparatus further executes:
storing a first indicator indicating whether the second process is being executed by the OS in the memory; and
second determining, when the first indicator indicates that the second process is being executed by the OS, that the second process can be executed by the OS.

8. The non-transitory computer-readable recording medium according to claim 6, wherein the information processing apparatus further executes:
storing a second indicator indicating whether the OS is instructed to execute the second process or the OS is instructed not to execute the second process in the memory; and
setting, when the second determining determines that the second process can be executed by the OS, the second indicator to indicate that the OS is instructed to execute the second process,
when the second indicator indicates that the OS is instructed to execute the second process, the OS executes the second process after the OS sets the second indicator to indicate that the OS is instructed not to execute the second process, and
the second determining determines, when the second indicator indicates that the OS is instructed to execute the second process, that the second process can be executed by the OS.
